(19) United States
(12) Patent Application Publication
(10) Pub. No.: US 2014/0266884 A1
(43) Pub. Date: Sep. 18, 2014

(54) SYSTEMS AND METHODS FOR MAINTAINING TIME SYNCHRONIZATION

(71) Applicant: NextNav, LLC, Sunnyvale, CA (US)

(72) Inventors: Arun Raghupathy, Bangalore (IN); Jagadish Venkataraman, San Jose, CA (US)

(73) Assignee: NextNav, LLC, Sunnyvale, CA (US)

(21) Appl. No.: 14/207,385

(22) Filed: Mar. 12, 2014

Related U.S. Application Data
(60) Provisional application No. 61/786,574, filed on Mar. 15, 2013.

(51) Int. Cl. G01S 19/24

(52) U.S. Cl. CPC G01S 19/24
USPC 342/357.63

(57) ABSTRACT

Described are systems and methods for time synching to a network in an environment that contains obstructions disposed between a receiver component and a transmitting device of the network. In particular, an adaptive masking approach and an outage approach may be used to maintain time synchronization to the network. The adaptive masking approach may be used to track satellites above predefined elevation angles that correspond to the obstructions. The outage approach may be used to maintain time synchronization when the transmitting device of the network is not in view of the receiver component.

### CROSS REFERENCE TO RELATED APPLICATIONS

This application claims priority under 35 U.S.C. §119(e) to co-pending U.S. Provisional Patent Application Ser. No. 61/786,574, filed Mar. 15, 2013, entitled TECHNIQUES FOR MAINTAINING TIME SYNC WITH GPS PPS IN GPS-CHALLENGED ENVIRONMENTS, the content of which is hereby incorporated by reference herein in its entirety for all purposes.

### FIELD

Various embodiments relate to wireless communications, and more particularly, to networks, devices, methods and computer-readable media for time synching to a network in an environment that contains obstructions disposed between a receiver and a beacon of the network.

### BACKGROUND

It is desirable to estimate the position of persons and things in a geographic area with a reasonable degree of accuracy. Accurate estimations of a position can be used to speed up emergency response times, track business assets, and link a consumer to a nearby business. Various techniques are used to estimate the position of an object. However, these techniques typically require that each transmitter be synchronized to a common time source, like a satellite system that transmits timing signals to each transmitter. Unfortunately, in urban environments, some transmitters are often installed in areas that lack a clear view of the satellite system at all times. As a consequence, those transmitters do not always receive accurate timing signals. Accordingly, there is a need for improved techniques for maintaining time synchronization of a transmitter that is located in an area that does not have a clear view of a time source during certain periods of time.

### SUMMARY

Certain embodiments of this disclosure relate generally to networks, devices, methods and computer-readable media for time synching to a network of satellites in an environment that contains obstructions disposed between a receiver and one or more of the satellites at different instances of time. Such networks, devices, methods and computer-readable media may track one or more satellites that are above one or more minimum elevation angles corresponding to different regions that extend outward from the receiver along a reference plane in order to synchronize a local device to a timing signal of at least one of those satellites. When no satellites are above the minimum elevation angles, the networks, devices, methods and computer-readable media may identify a frequency adjustment corresponding to a remote device that receives a timing signal from a satellite, and then use that frequency adjustment to synchronize the local device.

### DRAWINGS

FIG. 1 depicts a transmitter system.

FIG. 2 depicts a side-view perspective of signal pathways corresponding to elevation angles in an “urban canyon”.

FIG. 3 illustrates a process for identifying elevation angles.

FIG. 4 depicts a top-view perspective of viewing regions corresponding to a location of a receiver component and obstructions.

FIGS. 5A-B depict side-view perspectives of signal acquisition by a receiver component over time.

FIG. 6 depicts a system with two receiver component and oscillator combinations that are remotely located from one another.

FIGS. 7-18 illustrate operational characteristics of one or more embodiments.

FIG. 19 illustrates a process for tracking satellites based on different elevation angles, and for adjusting an oscillator to produce an output based on an adjustment made to a remotely-located oscillator.

### DESCRIPTION

A GPS disciplined oscillator (GPSDO) is a very accurate clock source that provides a pulse-per-second (PPS) output (and usually, also a 10 MHz output) that is in sync with GPS time. Typically, it includes a voltage-controlled oscillator (VCXO) in closed-loop with a receiver (e.g., GPS receiver) under open-sky conditions such that the VCXO constantly tunes its frequency to adjust to the rising and setting of GPS satellites through the day. The receiver mostly operates in a timing-only mode where it is placed in a pre-surveyed location such that it does not have to compute a position estimate, and must only determine a timing solution to control the VCXO.

Often, the combination of receiver and oscillator is located as a transmitters (e.g., a base station) so that output of the oscillator can act as a reliable clock source for transmission of signal from the transmitter that is synchronized to GPS time with a frequency as accurate as GPS oscillators. Using a GPSDO at each transmitter in a set of geographically-separated transmitter makes is possible to synchronize the transmitters to each other and to GPS time.

The successful operation of a time-disciplined oscillator (e.g., a GPSDO) is often contingent on producing an output (e.g., a PPS output) that is tuned to the timing a reference network (e.g., a satellite network). Usually, accurate output is possible only if the oscillator has visibility of at least one satellite (assuming the receiver is in timing-only mode). However, there may be scenarios where the transmitter (and its oscillator) will have to be installed in challenging locations for GPS, like an urban canyon formed by buildings and other obstructions affecting line-of-sight communications of timing signals between GPS satellites and the transmitter. Such locations are rife with the possibility of reflected (or “multipath”) signals from the satellites reaching the GPS receiver, in which case the computed PPS will be inaccurate.

In order to work around the problem of not having constant visibility of a satellite at a location of a transmitter, which often leads to an inaccurate PPS output from an oscillator of that transmitters, a receiver component at the transmitter can operate using a high elevation cut-off mask whereby the receiver does not use satellites that are below a certain elevation/altitude in order to ensure line-of-sight measurements. However, in doing so, there is no guarantee that there will always be at least one visible satellite above the chosen elevation angle, especially if the mask angle needs to be set greater than 60 degrees to avoid obstructions in all directions. In such cases, the GPS receiver experiences significant outage times, preventing the GPSDO from operating in closed loop and thus, rendering the PPS output of the GPSDO less useful or completely useless. Various solutions are disclosed herein, including a two-level approach to allow the PPS coming out of the GPSDO to stay closely in sync with GPS PPS at all times despite outages.

Using or starting with a first approach, an adaptive masking scheme that tailors itself to suit the particular location of the GPS receiver may be used to reduce or eliminate the duration of GPS satellite outages. In some cases, this scheme may not entirely eliminate the possibility of outages, but will aim to significantly reduce their durations. Using a second approach when outages occur, the VCXO may operate in an open-loop mode by controlling the parameters of its phase-locked loop (PLL) using a combination of control parameters saved from durations of closed loop operation in absence of GPS outage, and also short term variations of control parameters extracted in real time from a nearby GPSDO operating in closed loop while having clear view of sufficient GPS satellites.

The success of these approaches may depend on placing the transmitter at a location that optimizes its ability to receive line-of-sight communications from satellite(s) despite some outages.

### Placement of Transmitters to Enable Time Synchronization with a Network

Certain aspects of this disclosure relate to placement of transmitters that must synchronize to timing of a network. By way of example, a transmitter 100 is shown in FIG. 1, which depicts one or more receiver components (e.g., satellite RF component 140, terrestrial RF 150, or other receiving components) that acquire timing signals from a network (satellite, terrestrial, or other network). Further description of the transmitter 100 is provided later.

When determining where to place a transmitter, various environmental conditions may be evaluated. For example, surveying may determine where the transmitter can be placed to optimize the opportunity the transmitter has to receive accurate timing signals at various instances in time (e.g., to ideally receive line-of-sight signals from a satellite that is visible to the transmitter by comparison to receiving a multipath signal from a satellite that is not visible to the transmitter). Such surveying may compare different locations in a small geographic area—e.g., one or more city block(s), building roof top(s), and the like—to determine where a transmitter will optimally receive timing signals from the network. One location may be treated as optimal when placement of a transmitter at that location enables line-of-sight signal acquisition more often than at other locations in the geographic area, or more often during high load usage of the transmitter.

Various considerations may be made when determining where to place the transmitter, including presence of obstacles that block the transmitter's visibility to various satellites at different instances in time, thereby preventing line-of-sight signal acquisition from one satellite until that satellite moves into view at a later time. Such obstructions may include man-made obstructions (e.g., buildings), natural obstructions (e.g., mountains), atmospheric conditions, and the like. The size of obstacles (e.g., their height/altitude) relative to the position of the transmitter creates a viewing region within which satellites are visible to a receiver component at the transmitter, through which the receiver component may receive line-of-sight signals from the satellites.

In one embodiment, the heights of obstacles are determined in various directions at a location. Depending on variation in the heights of the obstacles, viewing regions are identified, where each viewing region is defined by a maximum height of buildings in that region. Each region may be further defined by a range of azimuths that correspond to boundaries within which certain buildings are located. The viewing regions may vary in size. Regions may be sized so a satellite will pass through that region as some point in time. Alternatively, non-viewing regions may be sized to a range of azimuths through which no satellite will pass. When searching for satellites, such non-viewing regions may be ignored by the receiver component of the transmitter. In some embodiments, the transmitter may automatically determine non-viewing and/or viewing regions by analyzing the quality of satellite measurements during a period of time (e.g., one or more 24 hour windows) along with the points of origin of those measurements. Comparisons between unacceptable (e.g., multipath measurements) and acceptable measurements (e.g., line of sight measurements) from the same satellite over time can be made to determine an elevation mask along a particular direction.

The receiver need not look at one particular satellite as the satellite traverses the sky. The receiver can sample the sky to obtain satellites at different elevations in the different regions (e.g., azimuth ranges). Since its location is pre-surveyed, the receiver can determine the measurement residuals from these different satellites. If the residuals lie within a certain threshold, the satellites can be deemed trustworthy, if not they can be discarded. This way, the receiver can potentially identify elevation angles that generate trustworthy measurements for each of the azimuth bins.

Once the viewing regions are identified, outage periods may be determined. An outage period may be defined as a time period when a minimum number of satellites are not in view at the location through some or all of the viewing regions. Depending on needs of the transmitter, the minimum number can vary, but will typically be at least 1 satellite.

The above process may be repeated for other locations. Comparisons may be made between locations to determine an optimal location for a transmitter relative to the other locations. For example, a location may be optimal when outage period(s) of that location are of a minimum length compared to outage period(s) of the other locations, or when the outage period(s) are during periods of low demand for the transmitter. Once placed, the transmitter may operate in an adaptive masking mode. Of course, additional considerations beyond satellite visibility, like radio frequency transmission coverage by the transmitter in relation to a mobile receiver, may constrain where a transmitter is placed.

### Adaptive Masking

FIG. 2 depicts an environment 200 within which a receiver component 240a operates. The receiver component 240a may include any number of receivers, including a satellite (e.g., GPS) or terrestrial receiver. It is noted that the receiver component 240a, which may be part of a base-station at a pre-determined position, can operate in a timing-only mode which requires a line-of-sight signal from one of the satellites 295a-b. Thus, one solution is for the receiver component 240a to operate by choosing an elevation mask angle that will make it more likely to obtain multipath-free reception from satellites all around the sky.

As shown, the receiver component 240a is located in an “urban canyon” formed by various obstructions 290a-b in multiple directions. The obstructions 290a-b, which may be man-made or natural, are depicted as high-rise buildings. The height of each building constrains an elevation angle above which a line-of-sight signal may be communicated to the receiver component 240a from a satellite.

As shown, a building 290a blocks a line-of-sight signal 293a from a satellite 295a because the satellite 295a is below elevation angle A. Also shown is a building 290b that does not block a line-of-sight signal 293b from a satellite 295b because the satellite 295b is above elevation angle B. Elevation angle A would universally solve the multipath problem from all azimuthal directions relative to the position of the receiving component 240a. Over the course of a day, however, the probability of at least one satellite being present above that angle is minimal, and the receiver component 240a would often be in outage if its search for satellites is restricted to searching for satellites above only elevation angle A. During this long outage time, the receiver's PPS will be out-of-sync with GPS PPS and cannot be used to discipline the VCXO effectively.

An alternate approach is to adapt the operation mode of the receiver to its surroundings. If the receiver is located in a street that runs north-south, for instance, it is highly likely that the receiver is flanked by buildings of various heights only on the east and west sides, and has relatively open view of the sky along the north-south direction. It is also true that not all of the buildings are of equal height and that the elevation angle might improve along certain directions, including a section of the street where flanking buildings are relatively low to permit a better elevation angle corresponding to satellites that may have previously been blocked by taller buildings. Thus, an adaptive masking scheme, as illustrated by FIG. 3 may be used as follows.

As shown by FIG. 3, possible receiver locations are selected within a particular environment (310). The receiver locations may be at ground level or at an elevated level corresponding to a level of an obstruction (e.g., a floor or rooftop of a building). It is noted that “ground level” may vary among candidate receiver locations. However, each location may be positioned along a 2-dimension reference plane defined by latitude and longitude coordinates. Obstructions may be positioned throughout the corresponding reference plane along various azimuths.

For each possible location of the receiver, the reference plane may be segmented into N segments (320). Segments may, for example, correspond to a range of azimuth(s) between 0 and 360 degrees. The segment centers may or may not be uniformly spaced so that some segments have a wider range of azimuths by comparison to other segments. The number N of segments may vary among different locations. Moreover, the corresponding number of azimuths in each segment for a particular location may vary from each other. FIG. 4 illustrates segmentation into viewing regions 1 through 6 that may be identified based on heights of obstructions 290 near the receiver component 240a. The regions may be bounded by ranges of azimuths relative to the location of the receiver component 240a. Regions 1, 3 and 5 may be defined by a low of no elevation angle since no nearby obstructions 290 are shown to exist. Regions 2, 4 and 6, other the other hand, may each be defined by an elevation angle that corresponds to the height of the obstruction 290 in the range of azimuths that bound that particular region.

For each segment, a minimum elevation angle that would increase the probability of multipath-free reception of the satellites is identified (330). The minimum elevation angle may be based on the heights and proximity of surrounding obstructions 290 in the segment (e.g., within the range of azimuths corresponding to the segment along the reference plane). It is noted that the elevation angles for particular segments may vary depending on the environment surrounding the location of the receiver component 240a.

The operation algorithm of the receiver component 240a may be modified such that it only tracks satellites that satisfy the elevation angle constraint in particular regions corresponding to the azimuths along which the satellites are visible at particular times (340). FIGS. 5A-B illustrate signal acquisition from different satellites between Time 1 (FIG. 5A) and Time 2 (FIG. 5B), where the satellites have moved from Time 1 to Time 2.

For simplicity in FIG. 5A, it is assumed that the obstruction 290a, Satellite-1 and Satellite-2 are positioned along azimuths within a first range of azimuths, and that 290b, Satellite-3 and Satellite-4 are positioned along azimuths within a second range of azimuths. At Time 1, the receiver component 240a may search for Satellite-2 but not Satellite-1 because Satellite-2 is visible, but Satellite-1 is not visible, above an elevation angle associated with the obstruction 290a. Similarly, the receiver component 240a may search for Satellite-3 but not Satellite-4 because Satellite-3 is visible, but Satellite-4 is not visible, above an elevation angle associated with the obstruction 290b.

For simplicity in FIG. 5B, it is assumed that the obstruction 290a and Satellite-1 are positioned along azimuths within the first range of azimuths, and that 290b, Satellite-2 and Satellite-3 are positioned along azimuths within the second range of azimuths. At Time 2, the receiver component 240a may search for Satellite-1 because it is visible above an elevation angle associated with the obstruction 290a. Similarly, the receiver component 240a may search for Satellite-2, but not Satellite-3 because Satellite-2 is visible, but Satellite-3 is not visible, above an elevation angle associated with the obstruction 290b.

The adaptive masking scheme illustrated by FIG. 3 through FIG. 5B may significantly reduce the outage time of the receiver component 240 since the elevation angle constraints will be low along some directions corresponding to particular regions of azimuths—e.g., where no obstructions obstruct the view of the receiving component 240a, or where objects have low heights. Experiments have shown that, for example, in particular location the outage times over a day can reduce to 25% as opposed to the 90% seen when a single elevation mask angle constraint is used. Further, the outage time does not typically occur in a big burst of time but rather in small outage periods spread throughout the day.

Despite the adaptive masking scheme, a VCXO may still need to generate a PPS that is synchronized (or nearly synchronized within some acceptable error) to GPS PPS during the outage times. This can be achieved by controlling the loop parameters of the VCXO's (phase-locked loop) PLL, as described further below.

### Outage

As depicted by an illustrative system 600 in FIG. 6, a line-of-sight signal 693 from a satellite 695 may not reach one receiver component 640a while reaching another receiver component 640b. Under such circumstances, the receiver component 640a experiences an outage relative to the line-of-sight signal 693 from the satellite 695 due to an obstruction 690 between the receiver component 640a and the satellite 695. However, there is no obstruction between the receiver component 640b and the satellite 695, thus making it possible for the receiver component 640b to receive the line-of-sight signal 693. As shown, each receiver component 640a-b is co-located with an oscillator 680a-b that provides a signal output that can be in sync with a timing signal from the satellite 695 so long as the receiver component 640a-b receives the line-of-sight signal 693, to which the oscillator 680a-b may be disciplined.

FIG. 6 illustrates a situation when the oscillator 680b disciplines itself to the signal 693 since the receiver 640b receives the signal 693. By comparison, the oscillator 680a cannot discipline itself to the signal 693 since the receiver 640a does not receive the signal 693. Under circumstances where the oscillators 680a and 680b are similar, it is possible to better align the timing of the oscillator 680a to the timing of the satellite 695 by adjusting the frequency of the oscillator 680a based on a frequency adjustment made to the oscillator 680b.

Communication of information that represents such a frequency adjustment may be achieved by wired or wireless communication pathways between the two oscillators 680a and 680b. For example, a processor (not shown) that is co-located with the oscillator 680a may request the information by identifying the location of the oscillator 680b (e.g., using an IP address or other identifier), and then requesting the information from the oscillator 680b, a co-located processor, or another component (e.g., a server or data source that stores the adjustment). The information may specify the frequency adjustment, or a control parameter that achieves the frequency adjustment if applied to a particular type of oscillator. One of skill in the art will recognize different control parameters—e.g., changes to magnetic field, voltage, others—that depend on which oscillator is used, and will further appreciate how each control parameter is provided to a respective oscillator to cause a change to the frequency associated with that oscillator.

Aspects of the Outage approach are further described below using a specific type of oscillator.

### Rubidium Frequency Standard

The following section will use a Rubidium (Rb) oscillator as the oscillators 680a and 680b, and demonstrate how PPS quality can be maintained within an accepted tolerance even during a GPS outage at the oscillator 680a. The Rubidium oscillator exhibits, among other characteristics, relatively low aging rate that make it a good component for network synchronization as disclosed herein. However, it is noted that other oscillators may be used in place of the Rb oscillator, including a Cesium oscillator or others.

The rubidium frequency standard operates by disciplining a crystal oscillator to the hyperfine transition at f_{Rb}=6.834682612 GHz in rubidium. Frequency offsets and long-term aging of the Rb oscillator can be eliminated by phase-locking to a source with better long-term stability, such as the 1 PPS from the receiver component 640. When an external 1 PPS signal is applied, the Rb oscillator will verify the integrity of that input and will then align its 1 PPS output with the external input. A processor (e.g., processor 110 in FIG. 1) will continue to track the 1 PPS output to the 1 PPS input by controlling the frequency of the rubidium transition with a small magnetic field adjustment inside the resonance cell.

Every Rb oscillator will age differently. Also, the base-plate temperature varies from part-to-part and, together with aging, an offset may be determined from f_{Rb} that is obtained when synchronizing the Rb oscillator to GPS. This offset represents a long-term effect and is specific to a particular module.

Consider, for example a pair of modules A and B that have offsets of f^{off}_{A} and f^{off}_{B} such that on initial sync up, a control loop parameter is applied that adjusts the magnetic field so that the frequency of superfine transition is adjusted to the GPS PPS-based frequency, henceforth referred to as SF. The SF values that the 2 modules settle at are SF_{A}=−|(f^{off}_{A/}f_{R}×10¹²)|, and SF_{B}=−|(f^{off}_{B/}f_{R}×10¹²)|, as shown below:

$${SF}_{A} = - ⌊ ( \frac{{f}_{A}^{off}}{{f}_{R}} \times {10}^{12} ) ⌋$$

$${SF}_{B} = - ⌊ ( \frac{{f}_{B}^{off}}{{f}_{R}} \times {10}^{12} ) ⌋$$

Now, once the long-term offset has been taken care of, the short term variation due to synchronization with GPS PPS should be similar across modules. For modules A and B, this variation will result in a Rb frequency of operation of f_{A}=f_{R}(1+f^{off}_{A/}f_{R}+SF_{A}+ΔSF_{A}), and f_{B}=f_{R}(1+f^{off}_{B/}f_{R}+SF_{B}+ΔSF_{B}), as shown below:

$${f}_{A} = {f}_{R} ( 1 + \frac{{f}_{A}^{off}}{{f}_{R}} + {SF}_{A} + Δ {SF}_{A} )$$

$${f}_{B} = {f}_{R} ( 1 + \frac{{f}_{B}^{off}}{{f}_{R}} + {SF}_{B} + Δ {SF}_{B} )$$

Given that SF_{A} and SF_{B} mostly cancel out the aging and temperature effects specific to A and B respectively, the short-term variation in SF should be similar, if not identical, for the 2 modules since they are synchronized to the same source. This would imply that

f_{A}=f_{B} [symbol] ΔSF_{A}=ΔSF_{B}

FIG. 7 shows the variation of ΔSF_{A} and ΔSF_{B} over 3 hours after the median SF value has been removed. It can be seen that the general short-term trend is similar for the 2 modules during this time. This information can be used to “transfer” SF values between modules. Thus, if module A is synchronized to GPS but B is not, module B can periodically ping A to determine the short-term variation in SF and adjust its SF accordingly. The definition of short-term can extend over a few hours comfortably as long as there is no major change in temperature of the 2 modules. Note that when considering an alternate VCXO in place of an Rb oscillator, such as an ovenized voltage controlled OCXO, the voltage control will correspond to the SF control parameter. The voltage control will correspondingly have a long term component and a short term component as for the SF parameter.

### Experimental results

The SF transfer method described above was tested using two Rb oscillators (e.g., one in a van, and another in a lab). Both oscillators were synchronized to their own GPS receiver modules for approximately 24 hours. The van oscillator was unlocked at about 1930 hours and its SF value is set to the median SF that was observed throughout the day. Alternatively, a different SF may be used. Every n seconds (e.g., 10 seconds), the unlocked van oscillator talked to the lab oscillator to determine the change in SF. The van oscillator then applied that change to its own SF value. This process continued for approximately 15 hours. Even though the van oscillator was unlocked from GPS PPS, it was still connected to the GPS PPS so that it could log its time tag throughout the unlocked period.

FIG. 8 through FIG. 10 show the status of the Rb in the lab during these 15 hours. FIG. 11 through FIG. 13 show the status of the van oscillator during this time. It is seen that as long as the van oscillator's temperature is within a couple of degrees of where it started from, it exhibits virtually no drift. In fact, the drift has zero mean during this time. Once the van starts heating up after 9 AM in the morning, the SF transfer mechanism no longer holds and the van oscillator starts drifting at approximately 20 ns/hr. This shows that the SF transfer mechanism holds water as long as the van oscillator does not show wild swings in its temperature. If such swings are inevitable, some sort of temperature coefficient should be incorporated into the SF value on top of the delta value it gets from the lab oscillator.

In order to obtain a temperature coefficient for characterizing the SF variation, the van oscillator was locked to GPS over 4 days, and its SF values were logged throughout the day as the van temperature heated and cooled. The plots of the case temperature (quantized to 0.5 degree segments) variation with respect to the time of the day, SF with time of day and SF with respect to temperature are shown in FIG. 14 through FIG. 16. Also shown in FIG. 16 are two fits to model the SF variation with respect to temperature, where one simply computes the median SF value for a given temperature, and the second computes a linear fit for the SF variation. FIG. 16 shows that the two models are comparable.

From the data shown in FIG. 16, the linear temperature coefficient for SF variation with respect to temperature was determined to be 1.3. This value may now be used to steer the van oscillator on top of the steering provided by the lab oscillator. FIG. 17 shows the time tag variation on an unlocked oscillator in the van over 14 hours. The van oscillator was constantly talking to the oscillator in the lab, and updating its SF value. The time tag shows minimal drift at accepted tolerance levels. The variation of SF with respect to time shown in FIG. 18 looks quite similar through FIG. 14. Thus, via modeling a temperature coefficient of the van oscillator and getting SF values (e.g., delta SF) from a master oscillator (e.g., the lab oscillator) that is in sync with GPS PPS, it is possible to achieve drifts in the time tag values that are well within an operational margin.

As illustrated by FIG. 14 through FIG. 16, changes in temperature may be correlated to changes in frequency. The correlation may be used to determine a frequency adjustment to a frequency setting of the oscillator in response to a change in temperature. Temperature changes may be monitored periodically (e.g., every n seconds), and frequency adjustments that correspond to the temperature changes may be made often to account for the changes. Similarly, other atmospheric conditions may be modeled to frequency changes, including pressure, humidity, and other conditions.

Data that represents frequency adjustments related to changes in temperature at an oscillator may be stored in a data source that is co-located with an oscillator, or located elsewhere. The data may specify control parameters that cause adjustments to the frequency. Of course, other oscillators may be used in place of the Rb oscillator, where frequency adjustments of those oscillators are carried out as would be understood by one of skill in the art. For example, a magnetic field, a voltage, or other parameter may be controlled to adjust the frequency. Control of each parameter may be carried out as would be understood by one of skill in the art. For example, control of the magnetic field itself may be accomplished by manually closing the frequency loop by externally providing an input that the closed loop would otherwise provide by itself. That external input makes the loop behave as if the magnetic field has changed. This can be mimicked for other control parameters like voltage, temperature, and others.

### Example Methodologies

Functionality and operation disclosed herein may be embodied as one or more methods implemented by processor(s) at one or more locations. Non-transitory processor-readable media embodying program instructions adapted to be executed to implement the method(s) are also contemplated. The program instructions are contained in at least one semiconductor chip.

By way of example, method(s) may comprise: identifying a plurality of regions defined by a respective range of azimuths associated with a first position in the environment, wherein the viewing regions extend outward from the first position along a reference plane of the environment; identifying, for each region, a minimum elevation angle at which at least one satellite will be visible from the first position at some point in time; and tracking satellite(s) corresponding to azimuth(s) that is/are visible above minimum elevation angle(s) of region(s) corresponding to the azimuth(s).

By way of example, method(s) for time synching to a network of satellites in an environment that contains obstructions disposed between a receiver and one or more of the satellites at different instances of time may comprise: identifying two or more regions that extend outward from a receiver along a reference plane, wherein each of the of regions is defined by a different range of azimuths; identifying two or more minimum elevation angles, wherein each of the two more minimum elevation angles correspond to a different region from the two or more regions; and tracking at least one satellite that is above at least one of the two or more minimum elevation angles.

Method(s) may further or alternatively comprise: tracking a first satellite that is visible only above a first minimum elevation angle of a first region corresponding to a first range of azimuths; and tracking a second satellite that is visible only above a second minimum elevation angle of a second region corresponding to a second range of azimuths.

In accordance with some aspects, the first minimum elevation angle is based on a first height of a first obstruction that is located within the first range of azimuths, and the second minimum elevation angle is based on a second height of a second obstruction that is located within the second range of azimuths, wherein the first height and the second height are different.

Method(s) may further or alternatively comprise: identifying a frequency adjustment applied to a frequency setting of a remote oscillator that is co-located with a remote receiver to which at least one of the satellites is visible; and using the frequency adjustment to cause an adjustment to a frequency setting of an oscillator that is co-located with the receiver.

In accordance with some aspects, the frequency adjustment is used to adjust the frequency setting of the oscillator when none of the satellites are visible to the receiver.

In accordance with some aspects, the frequency adjustment synchronizes the remote oscillator to a timing signal received by the remote receiver from the network of satellites.

Method(s) may further or alternatively comprise: identifying a change in operating temperature of the oscillator; determining an additional frequency adjustment that corresponds to the change in operating temperature; and using the additional frequency adjustment to cause an adjustment to the frequency setting of the oscillator.

In accordance with some aspects, the additional frequency adjustment is determined based on recorded changes in the frequency of the oscillator corresponding to changes in operating temperatures of the oscillator when at least one satellite was visible to the receiver.

Method(s) may further or alternatively comprise: identifying a change in operating temperature of an oscillator that is co-located with the receiver; determining a frequency adjustment that corresponds to the change in operating temperature; and using the frequency adjustment to adjust a frequency setting of the oscillator.

In accordance with some aspects, the change in operating temperature is identified, and the frequency adjustment is determined and used to adjust the frequency setting of the oscillator, when none of the satellites are visible to the receiver.

In accordance with some aspects, the additional frequency adjustment is determined based on recorded changes in the frequency of the oscillator corresponding to changes in operating temperatures of the oscillator when at least one satellite was visible to the receiver.

Any portion of the functionality embodied in the method(s) above may be combined with any other portion of that functionality.

Systems that carry out functionality (e.g., embodied as methods) may include one or more devices, including transmitter(s) from which position information is sent, receiver(s) at which position information is received, processor(s)/server(s) used to compute a position of a receiver and carry out other functionality, input/output (I/O) device(s), data source(s) and/or other device(s). Outputs from a first device or group of devices may be received and used by another device during performance of methods. Accordingly, an output from one device may cause another device to perform a method even where the two devices are no co-located (e.g., a receiver in a network of transmitters and a server in another country). Additionally, one or more computers may programmed to carry out various methods, and instructions stored on one or more processor-readable media may be executed by a processor to perform various methods.

### Other Aspects

Aspects of this disclosure are, in some sections, described in relation to a network of satellites. However, one of skill in the art will recognize various other networks that are capable of communicating with the transmitter, including networks of terrestrial towers which may include the transmitter. Although a GPSDO is discussed using a GPS receiver, the GPS receiver can be replaced by a receiver that tracks one or more satellites or terrestrial systems to provide timing. Some examples of satellite systems are Global Navigation Satellite Systems (GNSS), such as GLONASS, Galileo, and Compass/Beidou.

Description related to causing frequency adjustments of oscillators so they match the frequency of an incoming signal can extend to causing adjustments to other operational characteristics beyond frequency, as would be understood by one of skill in the art.

In some embodiments, a frequency adjustment to one oscillator may be used to adjust the operation of a second oscillator even when a line-of-sight signal is available to the second oscillator. In such embodiments, a full outage (i.e., no visible satellites) is not a requirement for applying the adjustment to the operation of the second oscillator.

Although not necessary, the distance separating oscillators (e.g., oscillators 680a and 680b) is preferably minimized to enable more-accurate syncing of the oscillator 680a.

Description related to a stationary transmitter (e.g., a transmitter with receiver component and oscillator) may extend to a mobile transmitter. Description may also extend to a mobile user device (e.g., mobile phone) that receives network timing signals and generates its own timing signals for transmission to other devices that are unable to receive the network timing signals due to outage.

### Transmitter

FIG. 1 illustrates details of a transmitter 100 at which signals may be received, and from which signals may be sent. The transmitter 100 is depicted as including components for performing associated signal reception and/or processing. These components may be combined and/or organized differently to provide similar or equivalent signal processing, signal generation, and signal transmission. As shown in FIG. 1, the transmitter 100 may include a satellite RF component 140 for receiving satellite signals and for providing, to a processor 110, location information and/or other data, such as timing data, dilution of precision (DOP) data, or other data or information as may be received from a satellite (e.g., GPS) network. The transmitter 100 may also include a terrestrial RF component 150 for receiving signals from a terrestrial network, and for generating and sending output signals. The processor 110 may carry out signal processing that interprets received signals and that generates output signals. One or more memories 120 may be coupled with the processor 110 to provide storage and retrieval of data and/or to provide storage and retrieval of executable instructions for performing functions described herein. The transmitter 100 may further include one or more oscillators 180 for producing a clock output (e.g., 1 pulse per second) that may be synchronized to a network's time (e.g., GPS time). One or more interface components 160 may also be included in the transmitter 100 to provide an interface between the transmitter 100 and other systems (e.g., other transmitters, including components at those transmitters).

### Other

The various illustrative systems, methods, logical features, blocks, modules, components, circuits, and algorithm steps described herein may be implemented, performed, or otherwise controlled by suitable hardware known or later developed in the art, or by firmware or software executed by processor(s), or any such combination of hardware, software and firmware.

Systems may include one or more devices or means that implement the functionality (e.g., embodied as methodologies) described herein. For example, such devices or means may include processor(s) that, when executing instructions, perform any of the methods disclosed herein. Such instructions can be embodied in software, firmware and/or hardware. A processor (also referred to as a “processing device”) may perform or otherwise carry out any of the operational steps, processing steps, computational steps, method steps, or other functionality disclosed herein, including analysis, manipulation, conversion or creation of data, or other operations on data. A processor may include a general purpose processor, a digital signal processor (DSP), an integrated circuit, a server, other programmable logic device, or any combination thereof. A processor may be a conventional processor, microprocessor, controller, microcontroller, or state machine. A processor can also refer to a chip or part of a chip (e.g., semiconductor chip). The term “processor” may refer to one, two or more processors of the same or different types. It is noted that a computer, computing device and user device, and the like, may refer to devices that include a processor, or may be equivalent to the processor itself.

A “memory” may accessible by a processor such that the processor can read information from and/or write information to the memory. Memory may be integral with or separate from the processor. Instructions may reside in such memory (e.g., RAM, flash, ROM, EPROM, EEPROM, registers, disk storage), or any other form of storage medium. Memory may include a non-transitory processor-readable medium having processor-readable program code (e.g., instructions) embodied therein that is adapted to be executed to implement the various methods disclosed herein. Processor-readable media be any available storage media, including non-volatile media (e.g., optical, magnetic, semiconductor) and carrier waves that transfer data and instructions through wireless, optical, or wired signaling media over a network using network transfer protocols. Instructions embodied in software can be downloaded to reside on and operated from different platforms used by known operating systems. Instructions embodied in firmware can be contained in an integrated circuit or other suitable device.

Functionality disclosed herein may be programmed into any of a variety of circuitry that is suitable for such purpose as understood by one of skill in the art. For example, functionality may be embodied in processors having software-based circuit emulation, discrete logic, custom devices, neural logic, quantum devices, PLDs, FPGA, PAL, ASIC, MOSFET, CMOS, ECL, polymer technologies, mixed analog and digital, and hybrids thereof. Data, instructions, commands, information, signals, bits, symbols, and chips disclosed herein may be represented by voltages, currents, electromagnetic waves, magnetic fields or particles, optical fields or particles, or any combination thereof. Computing networks may be used to carry out functionality and may include hardware components (servers, monitors, I/O, network connection). Application programs may carry out aspects by receiving, converting, processing, storing, retrieving, transferring and/or exporting data, which may be stored in a hierarchical, network, relational, non-relational, object-oriented, or other data source.

A data source may be used to store information, and may include any storage devices known by one of skill in the art. As used herein, computer-readable media includes all forms of computer-readable medium except, to the extent that such media is deemed to be non-statutory (e.g., transitory propagating signals).

Features in system and apparatus figures that are illustrated as rectangles may refer to hardware, firmware or software. It is noted that lines linking two such features may be illustrative of data transfer between those features. Such transfer may occur directly between those features or through intermediate features even if not illustrated. Where no line connects two features, transfer of data between those features is contemplated unless otherwise stated. Accordingly, the lines are provide to illustrate certain aspects, but should not be interpreted as limiting. The words “comprise,” “comprising,” “include,” “including” and the like are to be construed in an inclusive sense (i.e., not limited to) as opposed to an exclusive sense (i.e., consisting only of). Words using the singular or plural number also include the plural or singular number respectively. The words “or” or “and” cover both any of the items and all of the items in a list. “Some” and “any” and “at least one” refers to one or more. The disclosure is not intended to be limited to the aspects shown herein but is to be accorded the widest scope understood by a skilled artisan, including equivalent systems and methods.

1. A method for time synching to a network of satellites in an environment that contains obstructions disposed between a receiver and one or more of the satellites at different instances of time, the method comprising:
identifying two or more regions that extend outward from a receiver along a reference plane, wherein each of the two or more regions is defined by a different range of azimuths;
identifying two or more minimum elevation angles, wherein each of the two or more minimum elevation angles correspond to a different region from the two or more regions; and
tracking a satellite that is above at least one of the two or more minimum elevation angles.

2. The method of claim 1, the method further comprising:
tracking a first satellite that is visible only above a first minimum elevation angle of a first region corresponding to a first range of azimuths; and
tracking a second satellite that is visible only above a second minimum elevation angle of a second region corresponding to a second range of azimuths.

3. The method of claim 2, wherein the first minimum elevation angle is based on a first height of a first obstruction that is located within the first range of azimuths, and the second minimum elevation angle is based on a second height of a second obstruction that is located within the second range of azimuths, wherein the first height and the second height are different.

4. The method of claim 1, the method further comprising:
identifying a frequency adjustment applied to a frequency setting of a remote oscillator that is co-located with a remote receiver to which at least one of the satellites is visible; and
using the frequency adjustment to cause an adjustment to a frequency setting of an oscillator that is co-located with the receiver.

5. The method of claim 4, wherein the frequency adjustment is used to adjust the frequency setting of the oscillator when none of the satellites are visible to the receiver.

6. The method of claim 5, wherein the frequency adjustment synchronizes the remote oscillator to a timing signal received by the remote receiver from the network of satellites.

7. The method of claim 4, the method further comprising:
identifying a change in operating temperature of the oscillator;
determining an additional frequency adjustment that corresponds to the change in operating temperature; and
using the additional frequency adjustment to cause an adjustment to the frequency setting of the oscillator.

8. The method of claim 7, wherein the additional frequency adjustment is determined based on recorded changes in the frequency of the oscillator corresponding to changes in operating temperatures of the oscillator when at least one satellite was visible to the receiver.

9. The method of claim 1, the method further comprising:
identifying a change in operating temperature of an oscillator that is co-located with the receiver;
determining a frequency adjustment that corresponds to the change in operating temperature; and
using the frequency adjustment to adjust a frequency setting of the oscillator.

10. The method of claim 9, wherein the change in operating temperature is identified, and the frequency adjustment is determined and used to adjust the frequency setting of the oscillator, when none of the satellites are visible to the receiver.

11. The method of claim 9, wherein the additional frequency adjustment is determined based on recorded changes in the frequency of the oscillator corresponding to changes in operating temperatures of the oscillator when at least one satellite was visible to the receiver.

12. A system comprising one or more processors that perform the method of claim 1.

13. A non-transitory machine-readable medium embodying program instructions adapted to be executed to implement the method of claim 1.
